(19) United States
(12) Patent Application Publication
(10) Pub. No.: US 2025/0282618 A1
(43) Pub. Date: Sep. 11, 2025

(54) PROCESS FOR MANUFACTURE LITHIUM SALT OF BIS(FLUOROSULFONYL)IMIDE IN SOLID FORM

(71) Applicant: SPECIALTY OPERATIONS FRANCE, Lyon (FR)

(72) Inventors: Joo-Hee Kang, Lyon (FR); Philippe Carvin, Lyon (FR)

(73) Assignee: SPECIALTY OPERATIONS FRANCE, Lyon (FR)

(21) Appl. No.: 18/858,601

(22) PCT Filed: Apr. 12, 2023
(86) PCT No.: PCT/EP2023/059488

§ 371 Date: Oct. 21, 2024

(30) Foreign Application Priority Data
Apr. 21, 2022 (EP) 22305583.1

(51) Int. Cl. C01B 21/093

(52) U.S. Cl. CPC C01B 21/0935; C01P 2002/86; C01P 2002/90; C01P 2006/40

(57) ABSTRACT

The present disclosure relates to a process for preparing a lithium salt of bis(fluorosulfonyl)imide (LiFSI) in solid form, wherein the solid form LiFSI salt is extracted from a solution comprising at least one solvent through supercritical fluid extraction. The present invention also relates to the LiFSI in solid form obtained therefrom, as well as the use of such LiFSI in an electrolyte for batteries.

### CROSS-REFERENCE TO RELATED APPLICATION

This application claims priority to earlier European Patent Application No 22305583.1 filed on 21 Apr. 2022, the whole content of this application being incorporated herein by reference for all purposes.

### TECHNICAL FIELD

The present invention relates to a process for preparing the lithium salt of bis(fluorosulfonyl)imide (LiFSI) in solid form. The present invention also relates to the LiFSI in solid form obtained therefrom, as well as the use of such LiFSI in an electrolyte for batteries.

### BACKGROUND

Bis(fluorosulfonyl)imide and salts thereof, in particular the lithium salt of bis(fluorosulfonyl)imide (LiFSI), are useful compounds in a variety of technical fields, including in battery electrolytes.

The production of LiFSI is described in the literature. Among the various technologies described, the majority uses a fluorination reaction with a fluorinating agent in a solvent.

For example, WO 2017/090877 (in the name of CLS) describes a method for producing LiFSI comprising the steps of: (1) reacting bis(chlorosulfonyl)imide with a fluorinating reagent in a solvent, followed by treatment with an alkaline reagent, thereby producing ammonium bis(fluorosulfonyl)imide; and (2) reacting the ammonium bis(fluorosulfonyl)imide with a lithium base. The solvent used in step (1) is selected from the group consisting of alkyl ketones, including acetone, methyl ethyl ketone, and methyl isopropyl ketone; alcohols, including methanol, anhydrous ethanol, 1-propanol, and isopropanol; alkyl nitriles, including acetonitrile, and propionitrile; and ethers, including tetrahydrofuran, and dialkoxyalkane. The solvent is then removed by distillation and concentration under reduced pressure.

WO 2012/117961 (in the name of Nippon Soda) describes a process for producing a fluorosulfonylimide salt. According to examples 1 and 2, ammonium di(fluorosulfonyl)imide is prepared from di(chlorosulfonyl)imide in acetonitrile. The solvent is then removed by distillation under reduced pressure.

JP 2016145147 (in the name of Nippon Shokubai) relates to a method for providing a fluorosulfonylimide compound represented by the formula (1) by reacting a compound represented by the formula (2) and a compound represented by the composition formula (3) of 1 to 3 equivalence by stoichiometric amount based on 1 mol of the compound in a presence of a solvent of 0 to 4 mass times of the compound:

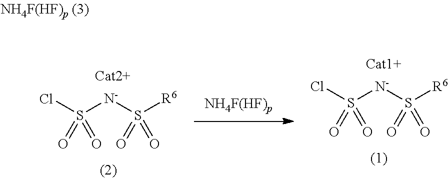

where R¹ is a C₁₋₆ fluoroalkyl group, R⁶ is halogen or a C₁₋₆ fluoroalkyl group, Cat1⁺ and Cat2⁺ are monovalent groups and p is an integer of 1 to 10.

JP 2014201453 (in the name of Nippon Shokubai) describes a method for producing an alkali metal salt of fluorosulfonyl imide which comprises a step of synthesizing an alkali metal salt of fluorosulfonyl imide in the presence of a reaction solvent containing at least one solvent selected from the group consisting of a carbonate-based solvent, an aliphatic ether-based solvent, an ester-based solvent, an amide-based solvent, a nitro-based solvent, a sulfur-based solvent and a nitrile-based solvent and, subsequently concentrating an alkali metal salt solution of fluorosulfonyl imide by distilling off the reaction solvent in the coexistence of the reaction solvent and at least one poor solvent for the alkali metal salt of fluorosulfonyl imide selected from the group consisting of an aromatic hydrocarbon-based solvent, an aliphatic hydrocarbon-based solvent and an aromatic ether-based solvent, the concentration step includes the step of mixing the above poor solvent with the reaction solution containing the reaction solvent and an alkali metal salt of fluorosulfonyl imide.

Supercritical fluid extraction has been used for recycling purposes. Notably, US 2003/0186110 (in the name of ECO BAT INDIANA LLC, ONTO TECH LLC), CN105406146 (in the name of HARBIN INST TECHNOLOGY) and CN110534835 (in the name of University of Changzhou) disclose a method for removing an electrolyte from an energy storage (e.g., a lithium battery) using supercritical fluids.

Supercritical fluid extraction has also been described in connection with the extraction of bis(fluorosulfonyl)imide (HFSI) from reaction mixtures comprising acids. Notably, WO 2021/082450 (in the name of GUANGZHOU LIWEN TECH CO LTD) discloses a method for purifying HFSI from a reaction mixture comprising a strong acid (e.g., concentrated sulfuric acid, phosphoric acid) and a FSI salt (e.g., NaFSI, KFSI or LiFSI among others) using supercritical extraction, in particular supercritical CO₂ fluid. Also, CN111517293 (in the name of SHANGHAI INST ORGANIC CHEMISTRY CAS) describes a method for preparing HFSI using supercritical fluid which comprises the following steps:

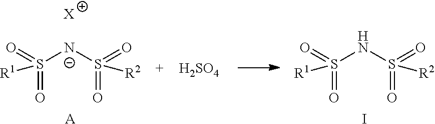

wherein X is an alkali metal; R¹ and R² are independently F or all-F substituted C1-12 alkyl.

### SUMMARY OF THE INVENTION

As described in the literature, the production of LIFSI by fluorination takes place in solvents, for example organic solvents, in order to disperse the reactive entities and allow them to react.

However, such solvents need to be removed after reaction to obtain an as pure as possible product which can be used for battery applications.

The Applicant is aware that the step for preparing a solid form LiFSI based on a LiFSI in solution is complex, especially when the amount of remaining solvent must be as low as possible in order to be well suited for battery electrolytes.

Thus, the Applicant faced the problem of developing a new process for the manufacture of LiFSI, which allows overcoming the complexities of the method known to date.

Unexpectedly, the Applicant developed a process for the manufacture of LiFSI, which is simple to perform in terms of apparatus and reaction conditions and very friendly from an environmental perspective.

Also, the process of the present invention allows to obtain LiFSI in solid form with a very high yield and high purity, such that it can be then used in a battery electrolyte solution.

The advantageous process for preparing LiFSI in solid form according to the present invention is based on supercritical fluid extraction.

Thus, a first object of the present invention relates to a process for preparing a LiFSI in solid form from a solution comprising at least one solvent and LiFSI salt, such process being based on the use of supercritical fluid.

### DRAWINGS

FIG. 1 represents a scheme of the laboratory setup used in Example 2.

### DISCLOSURE OF THE INVENTION

In the present application:
the expression “comprised between . . . and . . . ” should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

A first object of the present invention relates to a process for preparing lithium salt of bis(fluorosulfonyl)imide (LiFSI) in solid form, comprising the steps of:
a) providing a solution comprising LiFSI and at least one solvent [LiFSI solution];
b) contacting said LiFSI solution with at least one supercritical fluid; and
c) recovering the LiFSI in solid form.

The term “contacting” hereby means that the solution is in contact with the at least one supercritical fluid, for example in a vessel, under specific conditions of pressure and temperature, for a period of time sufficient for the fluid to remove at least part of the solvent present in the solution, preferably more than 80.0%, more than 90.0%, more than 95.0%, more than 99.0%, more than 99.5% or even more than 99.9% of the solvent.

The term “recovering” hereby means that the LiFSI in solid form is removed or extracted from the vessel wherein step b) takes place.

The expression “supercritical fluid” hereby means a gas (or a mixture of at least two gases) in its supercritical state. Depending on the gas employed in step b), the pressures and temperatures to be used in the vessel in which the contact between the solution and the supercritical fluid takes place are properly selected. More precisely, in order to be in a supercritical state, the gas employed in step b) is held at or above its critical temperature and critical pressure.

The term “vessel” hereby means a container that is well suited for the process of the present invention, that-is-to-say adapted to withstand the pressures and temperatures used in the process of the present invention, as well as to the possible corrosive character of the reactants and products involved in this process. As detailed below, the vessel used herein can notably be an extraction column (also referred to as “column”) or an autoclave.

According to the process of the present invention, at least one supercritical fluid is used to extract the LiFSI salt from the solution, with several advantages. Supercritical fluids, such as sCO₂, offer clear advantages, are usually easily available, inexpensive, non-toxic, non-explosive, and not organic solvents. Additionally, the process of the present invention operates at a moderate temperature (below 100° C.), which ensures a gentle treatment of the LiFSI product. The process of the present invention also allows an easy separation of the solvent(s) and the solid form extract.

Preferably, step a) is carried out in batch, semi-continuously or continuously.

As disclosed above, the LiFSI solution comprises at least one solvent. Preferably, said LiFSI solution comprises one solvent. Alternatively, said LiFSI solution comprises two or more solvents, for example a mixture of two or three solvents.

Preferably, said solvent is selected from the group comprising, more preferably consisting of: ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methyl sulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane, nitrobenzene, trifluoroethanol, and mixtures thereof.

More preferred solvents include ethylene carbonate, propylene carbonate, butylene carbonate, tetrahydrofuran, dimethyl carbonate, ethyl methyl carbonate, diethyl carbonate, ethyl acetate, isopropyl acetate and n-butyl acetate. Even more preferred solvents include dimethyl carbonate, ethyl methyl carbonate, diethyl carbonate, ethyl acetate, isopropyl acetate and n-butyl acetate. Still more preferred solvents include ethyl methyl carbonate and n-butyl acetate. The most preferred solvent is ethyl methyl carbonate.

In some embodiments, the LiFSI solution comprises between 5 and 70 wt. % of LiFSI, based on the total weight of the LiFSI solution.

Said LiFSI solution preferably comprises between 10 and 60 wt. % of LiFSI, for example between 15 and 50 wt. %, between 20 and 40 wt. % or between 25 and 35 wt. %. As an example, the solution comprises 30±2 wt. % of LiFSI, based on the total weight of the LiFSI solution.

The weight ratio of the supercritical fluid/LiFSI solution used in the process of the present invention may vary between 1/1 and 4000/1. For example, the weight ratio of supercritical fluid/LiFSI solution preferably varies between 10/1 and 3500/1.

It will be clear to those skilled in the art that the parameters of the process according to the present invention can be properly selected and optimized based for example on the starting material (in particular, on the purity of the product) and on the scale at which the process is performed, for example is the process is performed at industrial scale or at laboratory scale.

Preferably, step b) is carried out in a vessel at a pressure P of at least 73 bars (7.3 MPa).

Preferably, step b) is carried out at a temperature T between 30° C. and 90° C.

Step b) may preferably take place in a vessel, which is able to withstand high pressures.

According to this embodiment, step b) consists in contacting the solution of step a) with at least one supercritical fluid in a vessel.

A particular advantage of the process of the present invention is that the contacting time under step b) is short. Also, advantageously, the contacting time under step b) can be properly selected for example on the basis of the starting material and the desired yield.

Preferably, the contacting time under step b) varies between a few seconds, for example 5 seconds, and 24 hours. More preferably, the contacting time under step d) varies between 1 minute and 12 hours, for example between 5 minutes and 10 hours or between 10 minutes and 5 hours.

Preferably, step b) is performed by injecting the supercritical fluid at the bottom of the vessel. Advantageously, this allows improving the mixing of the LiFSI solution with the supercritical fluid.

Preferably, during step b), the LiFSI solution is contacted with one fluid in a supercritical state.

Preferably, during step b), the LiFSI solution is contacted with two or more fluids in a supercritical state. Said two or more fluids may be mixed or may be contacted with the solution sequentially. As an example, the LiFSI solution may be contacted with a mixture of at least two supercritical fluids.

Additionally, according to the present invention, at least one other component, also called herein modifier, may be mixed to the supercritical fluid(s).

Advantageously, said at least one other component is selected from polar solvents having a solubility in the supercritical fluid below 10 wt. % based on the total weight of the supercritical fluids and the other component(s).

More preferably, when used, said at least one other component is in an amount ranging from 0.1 to 10 wt. %, for example from 0.5 to 8 wt. % or from 1 to 6 wt. %, based on the total weight of the supercritical fluids and the other component(s).

Preferably, said at least one other component is selected from polar solvents, more preferably, in the group comprising: alcohol, toluene, dimethyl sulfoxide (DMSO), acetonitrile, and the like. According to a preferred embodiment, said polar solvent is alcohol. Even more preferably, said alcohol is ethanol.

According to the present invention, step b) may be repeated once or more than once.

For example, the process according to the present invention comprises a first step b) and a second step b′), wherein the same or different supercritical fluid(s), or a mixture of at least two supercritical fluids, are used in each of said step b) and said step b′).

In some embodiments, the vessel which is preferably used to contact the LiFSI solution with the at least one supercritical fluid under step b) is at a pressure P of at least 73 bars (7.3 MPa).

In some embodiments, the vessel that is preferably used to contact the LiFSI solution with said at least one supercritical fluid under step b) is at a temperature T between 30° C. and 90° C. during the extraction.

Preferably, the temperature T in the vessel may vary between 37° C. and 75° C., for example between 38° C. and 70° C. or between 40° C. and 65° C.

Preferably, the pressure P in the vessel may be at least 80 bars (8.0 MPa), at least 100 bars (10.0 MPa), at least 130 bars (13.0 MPa) or at least 150 bars (15.0 MPa). A very high pressure can be used also in the process of the present invention. For example, the pressure P in the vessel may be up to 200 bars (20.0 MPa) or 300 bars (30.0 MPa). The pressure in the vessel will usually be less than 500 bars (50.0 MPa), for example less than 450 bars (45.0 MPa), less than 400 bars (40.0 MPa), or even less than 350 bars (35.0 MPa).

According to an embodiment, step b) is carried out by injecting the LiFSI solution in the vessel, which is already pressurized. The LiFSI solution may for example be injected in the vessel through an injector or an entry valve mounted on the vessel.

According to another embodiment, step b) comprises:
b1) introducing the LiFSI solution in the vessel;
b2) pressurizing the vessel to a pressure P;
b3) heating the vessel to a temperature T; and
b4) introducing the at least one supercritical fluid in the vessel.

According to an embodiment, step b2) may be performed before step b3), or step b3) may be performed before step b2), or step b2) and b3) may be performed concomitantly.

Also, according to an embodiment, the sequence might be as follows: b1), b3), b4) and b2).

The conditions of temperature, pressure and contacting time detailed above with regard to step b), apply to step b2) and b3) as described above.

Preferably, step b2) is performed at a pressure of at least 74 bars (7.4 MPa). Preferably, step b3) is performed at a temperature of at least 30° C.

The flow rate for introducing the supercritical fluid in the vessel under step b4) is not particularly limited. The person skilled in the art can determine it based on the apparatus used and the amount and concentration of the LiFSi solution.

Step b4) can be performed in batch, continuously or semi-continuously.

Preferably, the supercritical fluid used in step b) comprises supercritical carbon dioxide (sCO₂). sCO₂ is a fluid state of carbon dioxide that is held at or above its critical temperature (31.0° C.) and critical pressure (7.3773 MPa).

Advantageously, the supercritical fluid used in step b) consists essentially in sCO₂, or it consists in sCO₂.

According to an embodiment, the sCO₂ is mixed with up to 10 wt. % of ethanol, for example with 0.1 to 8 wt. % of ethanol, the wt. % being based on the total weight of the supercritical fluid and the ethanol.

The process of the present invention may be carried out in a batch mode, in a continuous or semi-continuous mode.

According to an embodiment, the process is carried out in a continuous or semi-continuous manner.

For example, according to the present invention, the injection of the LiFSI solution in the vessel can be made in a continuous or semi-continuous manner. In other words, according to an embodiment, the LiFSI solution is continuously injected in the vessel or alternatively the LiFSI solution is semi-continuously injected in the vessel. For example, the LiFSI solution may be injected in the vessel for a certain time (as an example between 30 and 120 sec, for example 60 sec) and then the injection is stopped for another period of time, which can be equal to, shorter or longer than the injection time.

For example, according to the present invention, the supercritical fluid can be introduced in the vessel in a continuous or semi-continuous manner.

For example, the process of the present invention may comprise a step of continuously or semi-continuously withdrawing the salt of LiFSI from the vessel.

The LiFSI in solid form that is recovered in step c) is preferably in the form of a powder.

Under step c), the LiFSi in solid form can be recovered once step b) is finished or while step b) is proceeding.

According to a specific embodiment of step c), the solid LiFSI flows into a separator with the supercritical fluid. The pressure is released and the supercritical fluid becomes a gas. Such gas is preferably recycled, as detailed below.

The process of the present invention may further comprise additional steps, for example at least one step consisting in recycling the solvent and/or recycling the supercritical fluid.

Advantageously, the process of the present invention comprises the recycling of the solvent and the recycling of the supercritical fluid.

For example, the supercritical fluid may be re-injected in the process of the present invention as such or after additional step(s) of purification.

For example, the recycled solvent may be reused in a different process, for example the upstream process to prepare the LiFSI salt.

The recycling of the solvent and/or of the supercritical fluid may be performed in several ways.

According to an embodiment, the supercritical fluid may be recycled in a continuous way during the process. Preferably, it is recycled using a supercritical fluid pipe under pressure.

According to another embodiment, the supercritical fluid may be recovered as a liquid phase by releasing the pressure in the vessel, and then re-pressurizing it in its gas form, for example by means of a compressor, in order to recycle it as a supercritical fluid which can be rejected in the vessel.

The process of the present invention may be carried out in an equipment comprising:
a vessel, which withstands the pressure and temperature used, for example a pressure P of at least 73 bars and/or a temperature P above 30° C.;
a solvent trap;
a gas tank and a supercritical gas generator;
optionally, a solution tank;
at least one injector/entry valve mounted on the vessel; and
optionally a separator.

The vessel may preferably be made of sapphire, SS316L, glass or graphite filled PTFE.

The vessel can notably be a column or an autoclave.

The equipment may include a separator. Different separators may be used in the process of the present invention. In some embodiments, the separation of the liquid and the gas/fluid may be carried out through traditional filtration (also referred to as “dead end filtration”) or cross filtration, which is also called tangential filtration, as disclosed for example in US 2007/0021570 (in the name of Solvay SA.). Alternatively, cyclonic separators may be used, for example those which operate as liquid/solid or gas/solid separators. The cyclonic separators are advantageous as allow recovering the solids, which could plug the filter media. Several hybrid devices exist based on this principle. Reference can notably be made to U.S. Pat. No. 7,410,620 (in the name of North Carolina State University).

Preferably, the solid LiFSI is recovered at the end of the process via a frit filter.

For example, said frit filter can be made of stainless steel. Preferably, said frit filter has at least one of the following characteristics:
pore size between 1 and 6 μm, preferably from 2 to 4 μm;
diameter between 1 and 20 mm, preferably between 5 and 15 mm, more preferably about 10 mm; and/or
thickness from 0.1 to 5 mm, preferably between 0.7 and 3.5 mm, more preferably between 1.5 and 2.5 mm.

If the equipment comprises a filter, or several filters, the filter(s) may notably be positioned at the bottom or at the top of the vessel.

A second object of the present invention relates to the lithium salt of bis(fluorosulfonyl)imide (LiFSI) in solid form obtainable by the process of the present invention.

Advantageously, such LiFSI salt is characterized by containing a solvent in an amount of less than 50 ppm, as measured by Li NMR.

The amount of solvent in the LiFSI in solid form, for example in powder form, is preferably less than 40 ppm, less than 30 ppm, less than 20 ppm, less than 10 ppm or even less than 5 ppm.

The LiFSI salts of the present invention also preferably exhibit at least one of the following contents of chemical entities (as measured by Ion Chromatography):
a fluoride (F⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a sulfate (SO₄²⁻) content of below 30,000 ppm, preferably below 10,000 ppm, more preferably below 5,000 ppm, even more preferably below 1,000 ppm, still more preferably below 100 ppm, more preferably below 50 ppm and still more preferably below 20 ppm; and/or
a chloride (Cl⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm, more preferably below 8 ppm; and/or
an iron (Fe) content of below 1,000 ppm, preferably below 800 ppm, more preferably below 500 ppm; and/or
a chromium (Cr) content of below 1,000 ppm, preferably below 800 ppm, more preferably below 500 ppm; and/or
a nickel (Ni) content of below 1,000 ppm, preferably below 800 ppm, more preferably below 500 ppm; and/or
a zinc (Zn) content of below 1,000 ppm, preferably below 100 ppm, more preferably below 10 ppm, and/or
a copper (Cu) content of below 1,000 ppm, preferably below 100 ppm, more preferably below 10 ppm; and/or
a bismuth (Bi) content of below 1,000 ppm, preferably below 100 ppm, more preferably below 10 ppm; and/or
a sodium (Na+) content of below 10,000 ppm, preferably below 5 000 ppm, more preferably below 500 ppm; and/or
a potassium (K+) content of below 10,000 ppm, preferably below 5 000 ppm, more preferably below 500 ppm.

According to a third object, the present invention relates to a powder comprising lithium salt of bis(fluorosulfonyl)imide (LiFSI) and at least one other substance, said at least one other substance being selected from:
a solvent, preferably in an amount of less than 50 ppm, as measured by Li NMR; and/or
water, preferably in an amount up to or less than 50 ppm, as measured by KF; and/or
fluoride (F⁻), preferably in an amount of less than 25 ppm; and/or
chloride (Cl⁻), preferably in an amount of less than 8 ppm; and/or
sulfate (SO₄²⁻), preferably in an amount of less than 20 ppm; and/or
acid substances, preferably in an amount of less than 1 ppm.

Preferably, the solvent mentioned herein above is the same solvent used in the LiFSI solution, as provided under step (a).

Preferably, said acid substances are selected from NH₂SO₃⁻ and/or FSO₃⁻.

Advantageously, said powder as defined above is obtainable by the process according to the present invention.

A fourth object of the present invention relates to the use of lithium salt of bis(fluorosulfonyl)imide (LiFSI) of the present invention in a battery electrolyte solution.

A fifth object of the present invention relates to the use of supercritical fluid extraction for preparing a lithium salt of bis(fluorosulfonyl)imide (LiFSI) in solid form, from a solution comprising the LiFSI and at least one solvent.

Should the disclosure of any patents, patent applications, and publications, which are incorporated herein by reference conflict with the description of the present application to the extent that it may render a term unclear, the present description shall take precedence.

The present invention will be now described in more detail with reference to the following examples, whose purpose is merely illustrative and not intended to limit the scope of the disclosure.

### EXAMPLES

### Example 1—Preparation of the LiFSI Solution

The LiFSI solution was prepared as follows. The process was carried out in a 1 L reactor under N₂ with stirring means, a double jacket for thermal regulation, a condenser, a pressure regulator means and a liquid or gas addition means. At room temperature, 577.18 g of ethyl methyl carbonate (EMC) were introduced, and 145.77 g of anhydrous NH₄F were suspended. 190.52 g of bis(chlorosulfonyl)imide of formula (Cl—SO₂)₂—NH (HCSI) was added gradually during 1 hour, and the mixture was heated to less than 75° under stirring during 18-20 hours. The mixture was cooled to room temperature and 0.945 g of 25% NH₄OH (aq) (ammonia water) were added. The obtained mixture was stirred at room temperature for 2 hours and then filtered.

The product was then concentrated to 866.18 g, and 247.5 g of concentrated solution was transferred to a glass reactor. 371.3 g of dichloromethane were slowly added for 1 hour. Precipitated NH₄FSI was filtered, washed with dichloromethane, and dried in a vacuum oven to afford 144.5 g of NH₄FSI as a white solid.

110.12 g of crystallized NH₄FSI was solubilized in 902.7 g EMC. 23.37 g of a 25 wt. % aqueous solution of LiOH·H₂O was added. The obtained biphasic mixture was stirred for 1 hour at room temperature, and then decanted. The organic phase was recovered and put into a thin film evaporator at 60° C. under reduced pressure (10⁻¹ bar).

A solution of 30 wt. % LiFSI in EMC was obtained.

### Example 2—Preparation of the LiFSI in a Powder Form Starting from the LiFSI Solution of Example 1

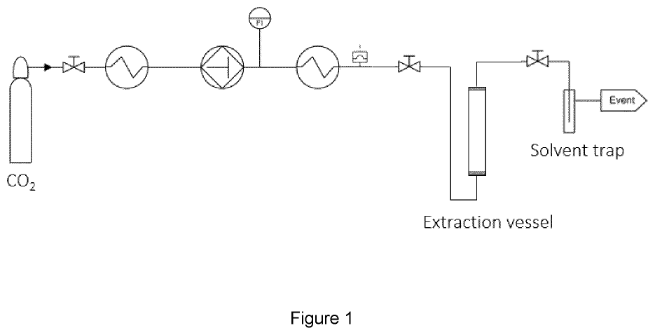

The equipment setup of FIG. 1 was used and the experiment was performed as follows.

8.907 g of LiFSI solution (2.67 g of LiFSI) obtained following the procedure in Example 1 was introduced into a vessel. The vessel was pressurized with sCO₂ (Temperature 45° C.; Pressure 200 bars). The exit valve was then opened at the desired level to set the flow rate of CO₂. After a contacting time in the vessel of about 90 min (sCO₂/LiFSI solution ratio from 3 to 80), the entry valve, between the buffer tank and the vessel, was closed so that the vessel and the exit line were depressurized.

### Results:

2.27 g of LiFSI salt (white and dry) were isolated in the extractor. The yield of extraction was therefore about 85%.

The water content was measured according to the Karl-Fischer analysis (oven method) as follows. The sample was prepared by a fully automated oven sample processor (Metrohm); sample weight 0.1 g, carrier gas=N₂, oven temperature=160° C. The titration was performed using a mixture of methanol and NH₄F (1:1 v/v). The polarization stream for potentiometric determination of reaction endpoint was 10 μA and titration endpoint voltage was 50 mV.

The water content in a sample of the LiFSI solid product was lower than 50 ppm.

No main impurities were detected by Ion Chromatography (DIONEX ICS-3000):
F⁻<20 ppm
Cl⁻<5 ppm
SO₄²⁻<15 ppm
NH₂SO³⁻ n/d (not detected)
FSO₃⁻ n/d (not detected)

A purity of more than 99.9% was determined by Li-NMR.

1. A process for preparing a lithium salt of bis(fluorosulfonyl)imide (LiFSI) in solid form, comprising the steps of:
a) providing a solution comprising LiFSI and at least one solvent [LiFSI solution];
b) contacting said LiFSI solution with at least one supercritical fluid; and
c) recovering the LiFSI in solid form.

2. The process according to claim 1, wherein said at least one supercritical fluid in step b) is selected from: one fluid in a supercritical state, or a mixture of at least two fluids in supercritical state.

3. The process according to claim 1, wherein said LiFSI solution comprises a solvent selected from the group consisting of: ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane, nitrobenzene, trifluoroethanol, and mixtures thereof.

4. The process according to claim 1, wherein said LiFSI solution comprises between 5 and 70 wt. % of LiFSI, based on the total weight of the LiFSI solution.

5. The process according to claim 1, wherein the LiFSI in solid form is in the form of powder.

6. The process according to claim 1, wherein step b) is carried out in a vessel at a pressure P of at least 73 bars (7.3 MPa) and/or a temperature T between 30° C. and 90° C.

7. The process according to claim 1, wherein said supercritical fluid(s) comprises CO₂, optionally in admixture with at least one polar solvent having a solubility in the supercritical fluid below 10 wt. % based on the total weight of said supercritical fluid and said at least one polar solvent.

8. The process according to claim 7, wherein:
the pressure P in the vessel is comprised between 80 bars and 500 bars; and/or
the temperature in the vessel is comprised between 35° C. and 80° C.

9. The process according to claim 1, wherein the process is carried out continuously or semi-continuously.

10. The process according to claim 1, further comprising at least one step of recycling the solvent and/or recycling the supercritical fluid.

11. The process according to claim 1, said process being carried out in an equipment comprising:
a vessel which can withstand a pressure P of at least 80 bars and a temperature T above 10° C.;
a solvent trap;
a gas tank and a supercritical gas generator;
optionally, a solution tank;
at least one injector/entry valve mounted on the vessel; and
optionally a separator.

12. A lithium salt of bis(fluorosulfonyl)imide (LiFSI) in solid form obtained by the process of claim 1, characterized in that said salt contains LiFSI and an amount of solvent of less than 50 ppm, as measured by Li NMR.

13. A powder comprising lithium salt of bis(fluorosulfonyl)imide (LiFSI) and at least one other substance, said at least one other substance being selected from:
a solvent, in an amount of less than 50 ppm, as measured by Li NMR; and/or
water, in an amount of less than 50 ppm, as measured by KF; and/or
fluoride (F⁻), in an amount of less than 25 ppm as measured by Ionic Chromatography (IC); and/or
chloride (Cl⁻), in an amount of less than 8 ppm as measured by IC; and/or
sulfate (SO₄²⁻), in an amount of less than 20 ppm as measured by IC; and/or
acid substances, in an amount of less than 1 ppm as measured by IC.

14. A method comprising incorporating a lithium salt of bis(fluorosulfonyl)imide (LiFSI) in solid form, formed from a method comprising the steps of:
a) providing a solution comprising LiFSI and at least one solvent [LiFSI solution];
b) contacting said LiFSI solution with at least one supercritical fluid; and
c) recovering the LiFSI in solid form
or of the powder of claim 13, in a battery electrolyte solution.

15. A method comprising extracting a lithium salt of bis(fluorosulfonyl)imide (LiFSI) in solid form, from a solution comprising LiFSI and at least one solvent, with supercritical fluid.
